(19) United States
(12) Patent Application Publication
(10) Pub. No.: US 2002/0131627 A1
(43) Pub. Date: Sep. 19, 2002

(54) Medical image generating apparatus, medical image processing apparatus and medical network system

(75) Inventor: Haruyuki Toda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/094,720

(22) Filed: Mar. 11, 2002

(30) Foreign Application Priority Data
Mar. 15, 2001 (JP) 073781/2001

(51) Int. Cl. G06K 9/00

(52) U.S. Cl. 382/132

(57) ABSTRACT

A medical image processing apparatus for conducting image processing by receiving medical image information from another apparatus. The medical image processing apparatus is provided with a means for reserving output of image information after image processing is conducted when information of inspection pending is included in the received image information, and a means for warning the inspection pending.

### BACKGROUND OF THE INVENTION

The present invention relates to a medical image processing apparatus that receives medical image information and conducts image processing and to a medical network system.

Radiographic images are commonly used for diagnoses of sickness, and a known method for obtaining the radiographic image is one wherein radiations which are emitted from a radiation emitting section and are transmitted through a subject are absorbed in a plate-shaped stimulable phosphor, then, the stimulable phosphor is scanned by a laser beam to be excited, thereby, radiation energy (radiographic image information) accumulated in the stimulable phosphor through the aforesaid absorption is made to radiate as fluorescence, and the fluorescence is subjected to photoelectric transfer to obtain radiographic image signals and thereby to read the radiographic image.

In a conventional system, image information is received from a medical image generating apparatus that reads medical image information in the aforesaid manner for image generation, and the images thus received are outputted automatically in the order of receiving. When reserving output of the reserved images, a user judges whether the reserving is necessary or not each time, and designates it. However, when the received images are outputted automatically in this manner, it is not possible to output a plurality of images concerned continuously, after image processing. In addition, it is necessary to judge whether a user wants to reserve outputting or not, and therefore, it is troublesome and may cause erroneous operations, which is not preferable.

### SUMMARY OF THE INVENTION

An object of the invention is to provide a medical image processing apparatus and a medical network system both make it possible to output a plurality of related images as a series of images after image processing, and are helpful for judging whether a user reserves outputting or not so that erroneous operations may be prevented.

For achieving the object stated above, the medical image processing apparatus of the invention is one for conducting image processing by receiving medical image information from another apparatus, and it is provided with a means that reserves output of image information after image processing when the aforesaid received image information includes information in which inspection pending is set in advance, and a means for warning the inspection pending.

In this case, the “inspection pending” means processing conducted for plural images in which continuity and connection have important meaning as medical information, and it means that series of images are reserved in the medical image processing apparatus for keeping the continuity and connection in the apparatus even in the case that images having the continuity and connection are read at random in the medical image generating apparatus. Namely, it means that a series of images having continuity and connection are reserved not to be inspected until the images become complete in the medical network system.

In the medical image processing apparatus, in the case of inspection pending, it is possible to wait until the moment when a plurality of related images in the same inspection can be outputted as a series of images, because information of inspection pending is included in image information to be received, and output of image processing after image processing is reserved automatically. Further, it is possible to inform a user of the state of inspection pending with a warning of inspection pending, and thereby to prevent erroneous operations. Incidentally, the inspection pending means pending of outputting until the moment when a plurality of images in the same inspection are outputted as a series of images.

Further, another medical image processing apparatus of the invention is one for conducting image processing by receiving medical image information from another apparatus, and it is provided with a means that reserves output of image information after image processing when the aforesaid received image information includes information in which inspection pending is set in advance, and with a means that cancels the inspection pending and starts output of the image information.

In the medical image processing apparatus, in the case of inspection pending, information of inspection pending is included in image information to be received, output of image information after image processing is reserved automatically, and outputting is started after the inspection pending is canceled, thus, a plurality of related images in the same inspection can be outputted after image processing as a series of images.

Further, another medical image processing apparatus of the invention is one that conducts image processing by receiving medical image information from another apparatus, and it is provided with a means that reserves output of image information after image processing when the aforesaid received image information includes information in which inspection pending is set in advance, a means to warn the inspection pending, and with a means that cancels the inspection pending and starts output of the image information.

In the medical image processing apparatus, in the case of inspection pending, information of inspection pending is included in image information to be received, output of image information after image processing is reserved automatically, and outputting is started after the inspection pending is canceled, thus, a plurality of related images in the same inspection can be outputted after image processing as a series of images. Further, it is possible to inform a user of the state of inspection pending with a warning of inspection pending, and thereby to prevent erroneous operations.

In the case of the foregoing, when the aforesaid medical image information represents a plurality of images in a long-roll film radiographing, a plurality of images in a multi-format or a plurality of images in contrast medium radiographing, a plurality of related images can be outputted as a series of images.

Further, another medical image processing apparatus of the invention is one for conducting image processing by receiving medical image information from another apparatus, and it is provided with a means that judges whether unconformity exists in the received image information or not and with a means that reserves output of image information after image processing when unconformity exists.

In this medical image processing apparatus, the received image information is judged whether it has unconformity or not, and when unconformity is present, output of image information can be reserved automatically before a user is judged whether it reserves processing of outputting or not, thereby, erroneous operations can be prevented.

Further, another medical image processing apparatus of the invention is one for conducting image processing by receiving medical image information from another apparatus, and it is provided with a means that judges whether unconformity exists in the received image information or not and with a means that warns the unconformity when it exists.

In this medical image processing apparatus, the received image information is judged whether it has unconformity or not, and when unconformity is present, it is warned, which is helpful for judging whether a user reserves outputting or not so that erroneous operations may be prevented.

The unconformity mentioned above means an occasion wherein patient information is different in plural images in the same inspection or an occasion of information of the image that is the same as one which has been received, and if such unconformity is caused, outputting can be reserved.

Further, another medical image processing apparatus of the invention is one for conducting image processing by receiving medical image information from another apparatus, and it is provided with a means that reserves output of image information after image processing when the aforesaid received image information includes information in which outputting pending is set in advance, and with a means that warns the output pending.

In the medical image processing apparatus, in the case of output pending, it is possible to wait until the moment when causes for output pending are removed and outputting becomes possible because information of output pending is included in image information to be received, and output of image information after image processing is reserved automatically. Further, it is possible to inform a user of the state of output pending with a warning of output pending, and thereby to prevent erroneous operations.

Further, another medical image processing apparatus of the invention is one for conducting image processing by receiving medical image information from another apparatus, and it is provided with a means that reserves output of image information after image processing when the aforesaid received image information includes information in which output pending is set in advance, and with a means that cancels the output pending and starts output of the image information.

In the medical image processing apparatus, when outputting is reserved, information of output pending is included in image information to be received, output of image information after image processing is reserved automatically, and outputting is started after output pending is canceled, therefore, it is possible to wait the outputting until causes for output pending are removed.

Further, another medical image processing apparatus of the invention is one for conducting image processing by receiving medical image information from another apparatus, and it is provided with a means that reserves output of image information after image processing when the aforesaid received image information includes information in which output pending is set in advance, a means that warns the output pending, and with a means that cancels the output pending and starts output of the image information.

In the medical image processing apparatus, when outputting is reserved, information of output pending is included in image information to be received, output of image information after image processing is reserved automatically, and outputting is started after output pending is canceled, therefore, it is possible to wait the outputting until causes for output pending are removed. Further, it is possible to inform a user of the state of output pending with a warning of output pending, and thereby to prevent erroneous operations.

The medical network system of the invention is one including a medical image generating apparatus that generates medical image information and transmits it to another apparatus and a medical image processing apparatus that receives the image information through the network and conducts image processing, wherein when information in which inspection pending or output pending is set in advance is included in image information to be transmitted from the medical image generating apparatus, the medical image processing apparatus reserves output of image information after image processing, then, cancels the inspection pending or the output pending, and starts output of the image information.

In the medical network system, when an inspection is reserved, it is possible to output a plurality of related images in the same inspection as a series of images after image processing, because information of inspection pending is included in image information received by the medical image processing apparatus, output of image information after image processing is automatically reserved and outputting is started after the inspection pending is canceled. Further, when outputting is reserved, it is possible to wait outputting until the cause of the output pending is canceled, because information of output pending is included in image information received by the medical image processing apparatus, output of image information after image processing is automatically reserved and outputting is started after the output pending is canceled.

In the medical network system, it is preferable that the aforesaid inspection pending is conducted when the medical image information represents a plurality of images in a long-roll film radiographing, a plurality of images in a multi-format or a plurality of images in contrast medium radiographing, and is canceled when the image processing apparatus receives all of plural images in the same inspection. Further, output pending is conducted, for example, when there is unconformity in the image information received by the image processing apparatus.

### BRIEF DESCRIPTION OF THE DRAWINGS

FIG. 1 is a diagram showing the structure of a medical network system in the embodiment of the invention.

FIG. 2 is a block diagram showing the structure of medical image generating apparatus 1 shown in FIG. 1.

FIG. 3 is a block diagram showing the structure of medical image generating apparatus 2 shown in FIG. 1.

FIG. 4 is a block diagram of a controller of medical image generating apparatus 1 shown in FIG. 2.

FIG. 5 is a diagram showing an example of an image confirming screen displayed on image display device 22 of an image processing apparatus in FIG. 3.

### DETAILED DESCRIPTION OF THE INVENTION

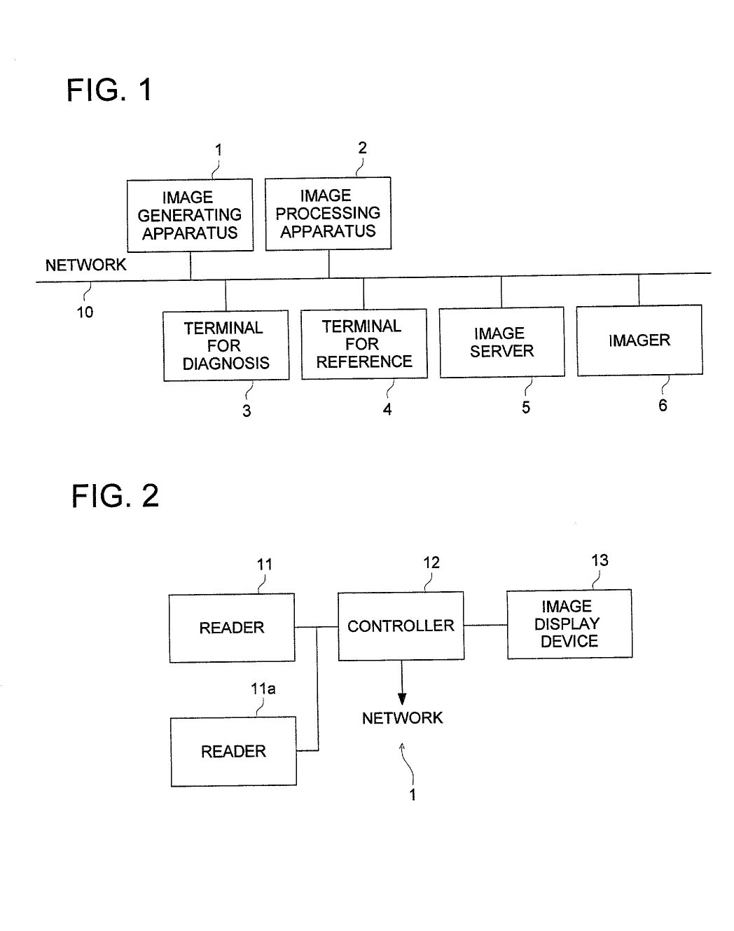

The medical network system in the embodiment of the invention will be explained as follows, referring to the drawings. FIG. 1 is a diagram showing the structure of a medical network system in the embodiment of the invention.

The medical network system shown in FIG. 1 is provided with medical image generating apparatus 1 wherein a medical image is generated by a radiographing modality of CR (computed radiography) that scans a stimulable phosphor panel in which radiographic image information of a subject (patient) is recorded to make it to emit light and transfers the light photoelectrically to obtain image information, medical image processing apparatus 2 that inputs an image file from the medical image generating apparatus 1 and outputs image information after conducting image processing, and with terminal for diagnosis 3 that is composed of a personal computer and a work station, and is used by a radiologist to diagnose by referring to images.

The medical network system shown in FIG. 1 is further provided with terminal for reference 4 that is composed of a personal computer and a workstation displaying images, and is inferior in quality such as resolution compared with the terminal for diagnosis 3 because no diagnosis is made although images are referred to, image server 5 that is composed of a personal computer and a workstation, and can store an image file in image data base and can detect images from the terminal for diagnosis 3 and from the terminal for reference 4 to read them, and imager (printer) 6 that outputs image data from medical image generating apparatus 1 and medical image processing apparatus 2 on a recording medium such as a film or paper. Each of the items 1-6 stated above is connected on an on-line connection basis through the network 10, so that information may be transmitted and received mutually.

Next, the following items A-I relating to medical image generating apparatus 1 in FIG. 1 will be explained in detail successfully.

A. Apparatus structure

B. Information

C. File

D. Input and display of main information

E. Reserving procedures

F. Radiographing procedures

G. Transfer

H. Output image forming

I. Utility function

A. Apparatus Structure

FIG. 2 is a block diagram showing the structure of medical image generating apparatus 1, and FIG. 4 is a block diagram showing the structure of a controller shown in FIG. 2.

a. As shown in FIG. 2, the medical image generating apparatus 1 is provided with radiographic image inputting apparatus (reader) 11 that converts information read from a stimulable phosphor panel on which radiographic image information of an object (patient) is accumulated and recorded to obtain, controller 12 that controls operations of the whole radiographing system for radiographic images, and image display device 13 that is composed of a CRT display or of a liquid crystal panel and displays digital image data obtained by the reader 11. Incidentally, the medical image generating apparatus 1 may also be provided with reader 11a, and it can include a plurality of readers. It further includes information inputting devices such as an input key board and a mouse.

b. The controller 12 constitutes a man-machine interface which is operated by a user (radiologist), and controls the whole of the medical image generating apparatus 1. As shown in FIG. 4, the controller 12 includes reading control section 36 that receives image data from readers 11 and 11a and conducts correction processing on a real time basis, preserving section 31 that is composed of a hard disc or RAM and stores and preserves various types of information such as image files from the reading control section 36, image processing section 32 that conducts image processing for image information in the image files, output image forming section 33 that forms output images to be outputted to the outside, image confirming/processing section 35 that conducts image processing for image confirmation and makes display device 13 to display reduction images, and main control apparatus 34 that controls operations of the whole apparatus including various sections 31-33 and 35 and the display device.

c. The controller 12 conducts the following operations (1)-(7) to be concrete.

1) A user operates for an appointment of radiographing.

2) A user operates for radiographing.

3) To receive image data obtained through reading by readers 11 and 11a.

4) To preserve image data in preserving section 31 temporarily.

5) To conduct image processing at image processing section 32.

6) To form output images at output image forming section 33.

7) To transmit to an outer apparatus such as image server 5 through the network 10.

B. Information

Information handled by the medical image generating apparatus 1 can be classified into the following five types of information.

a. Radiographing Information

Information with which radiographing is conducted to obtain image data which are outputted to an outer apparatus such as image server 5 as an image file.

The radiographing information includes the following information.

(a) Reader Reading Condition

Information concerning a method for reading by readers 11 and 11a, namely, an area to be read, a pixel size for reading and sensitivity for reading.

(b) X-ray Apparatus Information

Control information in the case of an occasion where a radiographing apparatus is connected to the network 10 on an on-line basis and is controlled from the system shown in FIG. 1, namely, X-ray tube voltage, X-ray tube current, X-ray radiation time and an area for radiation.

(c) Image Processing Information

Information relating to gradation processing and frequency processing in image processing of image data at image processing section 32.

(d) Outputting Apparatus Information

It is information relating to outer outputting apparatuses such as terminal for diagnosis 3, terminal for reference 4, image server 5 and imager 6 in FIG. 1 which reproduce image data for outputting them, and various pieces of information such as an area to be outputted, magnification and rate of reduction, output format (multi-format, split radiographing format), overlay and existence of gradation processing and frequency processing are designated for each outputting apparatus.

(e) Overlay Information

Information about existence and position of overlay such as AP/PA, R/L and comment.

(f) Information about Specific Designation

Information of protection: Image file is preserved in preserving section 31 until a protection is removed, even after image transmission.

Information of pending: Transmission is reserved. This is designated when transmission is needed after the image is reviewed.

Information of priority (emergency): This is designated when preferential transmission such as emergency radiographing is required. This is registered to be at the forefront of a cue.

b. Patient Information

Information concerning patients including the following information.

(a) Patient ID Information

An ID number, a full name, the distinction of sex and the date of birth of a patient.

(b) Order Information

Information with which a doctor requests radiographing, which includes information relating to patient conditions and instructions for the date and method for the inspection requested.

c. Information of Radiographing Implementation

Information concerning the results of radiographing which includes the following information.

(a) Results of Radiographing

Date and number for radiographing.

(b) Results of Image Processing

This is a result of calculation of image processing parameter, and image data are processed at image processing section 32 based on this result when outputting.

(c) System Information

This includes a part of system information such as a system structure at the point of time when radiographing is conducted.

d. System Information

This is information for controlling the whole system in FIG. 1, and it includes established information relating to outputting apparatuses such as system structures (outer apparatus such as image server 5 connected and it name), parameter to control equipment constituting the system, a table, reader information, imager information and HOST information.

e. Image Data

The following image data are included.

(a) Image data inputted from readers 11 and 11a.

(b) Reduction image data for display for making image display device 13 to display for image confirmation.

(c) Reduction image data for image processing for image processing of reduction image for display at image confirming/processing section 35.

(d) Output image data such as gradation processing and frequency processing.

C. File

A file handled by medical image generating apparatus 1 is preserved in preserving section 31, and it is classified into the following seven files.

a. Condition File

A radiographing condition key is a key for setting in advance radiographing conditions, image processing conditions and outing conditions, and it has a condition file that corresponds to each radiographing condition key. The condition file is composed of the radiographing information above mentioned. It is classified in terms of radiographing regions (lung, abdomen, head and others), radiographing posture (standing posture, lying posture and others), radiographing direction (front, side and others), characteristics of a patient (the distinction of sex, age, physical structure and others), the name of a disease and a radiologist, and a name and radiographing information corresponding to each of them are established in advance. Controller 12 establishes a condition file group for each of classified plural classifications, then, sets plural condition files for each condition file group thus established, and preserves in preserving section 31. The optimum condition is selected in the course of generating images.

b. Reservation File

This is a file in which information relating to radiographing reservation is preserved. One reservation file is prepared for each radiographing. The reservation file is composed of radiographing information selected by a radiographing condition key and of patient information.

c. Image Header File

After completion of radiographing, an image header file is prepared. The header file is composed of a reservation file of the radiographing (namely, radiographing information, patient information) and information of conducting radiographing. When a user refers to radiographing information, patient information and information of conducting radiographing for changing, the user refers to an image header file.

d. Reduction Image File

This represents image data-which are obtained by reducing image data by image confirming/processing section 35 at a certain reduction ratio for image confirmation, and it includes the following. Incidentally, a method of image reduction includes a simple thinning out method, an averaging method and a spline method.

(a) Reduction Image Data for Display

This reduction image for display is used by image data displayed on image display section 13 in FIG. 2 and FIG. 4.

(b) Reduction Image Data for Image Processing

This represents reduction image data for calculating a parameter with which the image confirming/processing section 35 conducts image processing. The reduction rate is determined so that a length of one pixel after reduction may be the same as a length designated in advance. Due to this, it is possible to correct the difference in a size of a pixel to be read with the image after being reduced. Calculation of a parameter for image processing is conducted by the reduction image for image processing, and image data are not used.

e. Image Data File

Corrected image data received from readers 11 and 11a in FIG. 2 are preserved in preserving section 31.

f. Output Image Data File

This is a file of output image data which have been subjected to the designated processing among frequency processing, gradation processing, overlay, rotation and enlargement and reduction.

g. System File

This is one wherein the system information mentioned above is filed.

D. Inputting and Display of Main Information

a. Reading Area

1) The reading area is an area where radiographic images accumulated in a stimulable phosphor are converted into image data. An appropriate area is designated in accordance with a region to be radiographed.

2) A size for reading, a direction and a position are designated, and registered in a condition file in advance.

3) When a condition file is selected, the reading area is displayed on a screen of image display device 13 in FIG. 2 under the condition designated in advance. A size of a display area of the reading area on the screen of the image display device 13 is made to be the maximum reading area in reading (normally, a 345×430 mm size). The reading area is determined from the designated reading size, the direction and the position, and is displayed graphically on the reading area display area. Due to this, appropriate reading size, direction and position can be selected and confirmed.

4) An irradiated area is received from an X-ray apparatus, and is displayed simultaneously on the reading area display area.

b. Output Area

1) The output area is an area for outputting to an outer apparatus such as image server 5.

2) An outputting size, a direction, a trimming position, an outputting position and a method of enlargement and reduction are designated, and registered in a condition file in advance.

3) When a radiographing condition key is selected, the output area and output image area are determined under the condition designated in advance, and are displayed on the screen of the image display device 13. A size of the output area display area on the screen of the image display device 13 is made to be the maximum output area in outputting. An output area and an output image area are displayed graphically on the output area display area. Due to this, the appropriate output area and the output image area can be selected and confirmed.

c. Overlay Information

1) It is designated whether or not “AP”, “PA”, “R”, “L”, comment and a division are overlaid, or where they are overlaid, and they are registered in a condition file in advance.

2) Output images are displayed on an output area display area on the screen of the image display device 13, and overlay information is displayed graphically there.

3) If a portion on the output area display area which needs to be overlaid is touched, overlay graphics are moved to that portion.

4) It is possible to select an appropriate overlay and to designate a position.

5) It is possible to confirm that a portion screened by the overlay to be invisible is not present. When the overlay causes troubles on diagnoses, it can be moved.

d. Inputting and Output of On-line Information from RIS

1) Orders from a doctor are inputted. The orders thus inputted are converted into the format of this system to be preserved in the reservation file. The radiographing region and radiographing method are converted into corresponding radiographing conditions.

2) An image header file is converted into the format on the RIS side, and outputted.

e. Reservation List

1) Reservations for radiographing can be displayed on the screen of the image display device 13 as a list in the order of reservations.

2) After completion of radiographing, the reservation for radiographing registered to be in the forefront of the reservation list is automatically set by controller 12 to be ready for radiographing.

3) The reservation for which radiographing has been finished is not erased, and is preserved until the number of the finished reservations arrives at the designated value. Due to this, retaking under the same condition and for the same patient such as retaking after confirmation of hard copy can be conducted easily.

E. Reservation Procedures

There are three inputting methods depending on environment of facilities where the system shown in FIG. 1 is installed.

a. On-line

1) Information necessary for radiographing such as patient information and radiographing information are mostly inputted from RIS in image generating apparatus 1 through the network 10 on an on-line basis.

2) A key board is not needed usually. When information that is not included in information from RIS needs to be inputted, an information inputting apparatus such as a key board is used.

3) Patient information is reserved through a multi-task basis even when radiographing, by inputting orders from a doctor on an on-line basis. Usually, setting is made for each facility so that all pieces of information relating to the patient may be taken in.

4) With regard to radiographing information, orders from a doctor are inputted together with patient information on an on-line basis, and the doctor selects the optimum radiographing method from radiographing key in the case of an order. Or, controller 12 automatically selects the radiographing condition key which is most suitable for the order designated by the doctor.

b. Magnetic Card, Bar Code and Others

1) Only necessary and minimum information such as an ID number or a patient name is inputted on an on-line basis

2) When information that is not included in a card needs to be inputted, it is inputted from the key board.

3) With regard to patient information, necessary and minimum information relating to radiographing is read from a magnetic card. In case of need, collateral information is inputted from a key board.

4) With regard to radiographing information, a radiographing condition key used for preceding radiographing is selected automatically by controller 12. When a change is needed, selection is made from the inside of the radiographing condition key.

c. Key Board Input

1) Necessary information is totally subjected to key board inputting.

2) Patient information is inputted from a key board. Since it is time-consuming to input all of patient ID numbers and patient names manually, it is possible to use a mode to prepare a patient ID number automatically from the number of sheets radiographed (number of sheets which have been radiographed) and radiographing time, to correspond to the order written on a sheet of paper.

3) Radiographing information is selected from a radiographing condition key.

F. Radiographing Procedures

a. The following represents procedures which are followed by a user for radiographing.

1) When the preceding radiographing is completed, or when the sequence enters a radiographing mode, a screen for the following radiographing appears, and radiographing information for radiographing reserved to be at the forefront is displayed on a screen of image display device 13.

2) When there is no reservation, the reservation needs to be made by selecting a radiographing condition key here. A default is a radiographing condition key used in the preceding radiographing. When information for radiographing is insufficient, necessary information needs to be inputted here.

3) A user observes patient information and radiographing information displayed on a screen of the image display device 13 in FIGS. 2 and 4, and confirms whether the setting is correct or not.

4) A user (radiologist) radiographs in the same way as in radiographing by means of a film.

5) Images obtained through radiographing are displayed on a screen of the image display device 13 in succession simultaneously with image reading.

6) Gradation processing is conducted to be displayed again.

7) Success or failure for radiographing and success or failure for processing are displayed on a message basis.

8) A user confirms from images and messages that radiographing has been conducted correctly, and pushes a key for completion of radiographing.

9) When radiographing fails, a user pushes a key for retaking.

b. System Operations in Radiographing

(1) Radiographing mode is started (a radiographing mode key is pressed). When detecting that a radiographing mode key is pressed, the controller 12 makes a control mode to move to a radiographing mode.

(2) When a reservation is made in advance (a reservation file is present), the contents of reservation registered to be at the forefront of a cue for controlling a reservation file are displayed on a screen of the image display device 13.

(3) When there is no reservation, a radiographing condition key used for preceding radiographing is selected automatically by controller 12. If reservation is needed, re-selection and correction of the radiographing condition key and inputting of patient information are conducted.

(4) Radiographing is started by pressing a radiographing switch of a radiation emitting device.

(5) X-rays are irradiated on a subject from the radiation emitting device, and radiographic images accumulated in a stimulable phosphor panel are read by readers 11 and 11a through scanning by excitation light.

(6) Reading control section 36 receives image data from the reader, and stores them in a memory for images while conducting correction processing on a real time basis.

(7) The image data stored in a frame memory are reduced, at image confirming/processing section 35, at the reduction rate designated in advance.

(8) Reduction images obtained through processing in the image confirming/processing section 35 in succession are displayed on a screen of the image display device 13.

(9) After completion of reading and display, digital image information is subjected to image processing in a method designated by a radiographing key in advance, and is displayed again. Reduction images are utilized for image processing.

(10) At the same time, the digital image information is stored in preserving section 31 temporarily.

(11) Images displayed in succession on the image display device 13 and subjected to gradation processing after displaying are displayed again.

(12) After reading is completed, a reservation file and information of conducting radiographing are preserved in preserving section 31 as an image header file.

(13) Reduction image data are preserved in preserving section 31 as a reduction image file.

(14) An image header file and a reduction image data file are controlled together with image data to be corresponded with a common specific number.

(15) Preservation of these files in preserving section 31 is conducted automatically by main control apparatus 34 of the controller 12, after completion of reading by readers 11 and 11a and before confirmation operations of an operator. The reason for this is to prevent that images obtained through radiographing may not be lost even when the power supply is turned off immediately after completion of reading by the accident or by erroneous operations of an operator, even when troubles are caused on the system.

(16) After completion of reading, operations of an operator turn out to be possible.

(17) When an operator judges the radiographing to be normal by observing radiographic images displayed on the image display device 13, a key (key for succeeding radiographing key) for confirming completion of radiographing is inputted from a character information inputting device, and radiographing is completed.

(18) When patient information, an image processing method and an outputting method are required to be changed, it is possible to input new information from the character information inputting device.

(19) When the succeeding radiographing key is pressed, radiographing corresponding to that key is completed, and the following reservation is displayed automatically on the image display device 13.

(20) When the radiographing is judged to have failed, it is possible to cancel the image and to retake by pressing a retaking key.

(21) When the succeeding radiographing key is pressed, radiographing corresponding to that key is completed, and the following processing is conducted.

(22) The reservation file is preserved in preserving section 31 as a radiographed reservation file.

1) When there is a change of information before the succeeding radiographing key is pressed, an image header file preserved at the moment when reading is completed is updated.

2) An image for which radiographing has been finished is registered in a cue for transmission to an outer apparatus.

3) The reservation file reserved next is read and displayed to be capable of being radiographed.

(23) When a retaking key is pressed, radiographing is completed, and the following processing is conducted.

1) Image header file and reduction image file and image data which are preserved at the point of completion of reading are destroyed.

2) Radiographing in the same reservation turns out to be possible.

G. Transmission

(1) Transmission is conducted on a non-synchronization basis.

(2) A cue is made and controlled for each outer apparatus, and each cue operates independently each other, and does not influence each other. Therefore, transmission is conducted for each apparatus on a non-synchronization basis.

(3) Numbers each being given to each image are preserved in a cue in the order of transmission.

(4) The whereabouts of the image in terms of registration in a cue of an outer apparatus is preserved in preserving section 31 as a cue registration table, and it is updated and controlled for each registration and cancellation.

(5) An image registered in the cue is transmitted to an outer apparatus of image server 5 in the order of registration, and the image whose transmission is finished is canceled from the cue.

(6) When carrying out transmission, an image header file and an image data file both stored in preserving section 31 are specified from numbers registered in the cue.

(7) An output image is formed under the condition preserved in the image header file. The image header file is converted into the format determined for each outputting apparatus, and is transmitted together with image data file.

H. Forming Output Image

a. An output image is formed by output image generating section 33 mainly through the following processing.

1) Image data are read from preserving section 31 to a memory for images.

2) Frequency processing is conducted.

3) Equalization processing is conducted.

4) Gradation processing is conducted.

5) Rotation of an image is carried out.

6) Mirror reversing is conducted.

7) Enlargement and reduction are carried out.

8) Overlay is carried out.

b. With respect to each of 2)-8), whether it is executed or not can be designated by radiographing information for each outputting apparatus such as image server 5.

c. It is possible to designate that image data subjected to designated processing of each of 2)-8) are preserved as processed image data file. Re-processing of common processing section of output image for each output apparatus is removed.

d. For example, when an enlargement rate and a reduction rate of an output image for each output apparatus are different from others, if images which have been subjected to processing up to 6) are preserved, it is possible to shorten a period of time for 2)-6) by reading images which have been subjected to processing up to 6) and by processing and transferring only 7) and 8), when transmitting to another apparatus.

e. Processing 5) and 6) are conducted simultaneously with either one of 2), 3) and 4). Access of memory is reduced, and processing time can be shortened.

I. Utility Function

As a utility for a user, some functions are provided thereto.

a. Utility function is restricted by a password for each of general user, a manager and a maker. In particular, for a change of information relating to images, a password of a manager is required for security.

b. Image file operation

1) An image file list is displayed, and information concerning images preserved in preserving section 31 is displayed on image display device 13 in the order of radiographing.

2) When a desired image is selected from the list, patient information, radiographing information and thinned out images are displayed in the same form as in the screen in the case of radiographing.

3) Patient information, image processing methods and outputting methods can be changed.

4) With regard to the image designated to be “reservation” in the case of radiographing, the “reservation” can be canceled by reconfirming here.

5) The image file list can be rewritten in the order of outputting to each outer apparatus.

6) The order of outputting can be changed, including whether outputting to each outer apparatus is conducted or not.

c. Radiographing record, emission record

1) Radiographing information and patient information are processed statistically, and are provided to a user as a radiographing record and an emission record.

2) The number of shots per each radiographing region for a designated period and a list of radiographing conditions for shots per day can be outputted.

Next, the following items A-H relating to medical image processing apparatus 2 shown in FIG. 1 will be explained in detail.

A. Apparatus structure

B. Information

C. File

D. Input and display of main information

E. Image confirming procedures

F. Output

G. Formation of output image

H. Utility function

A. Apparatus Structure

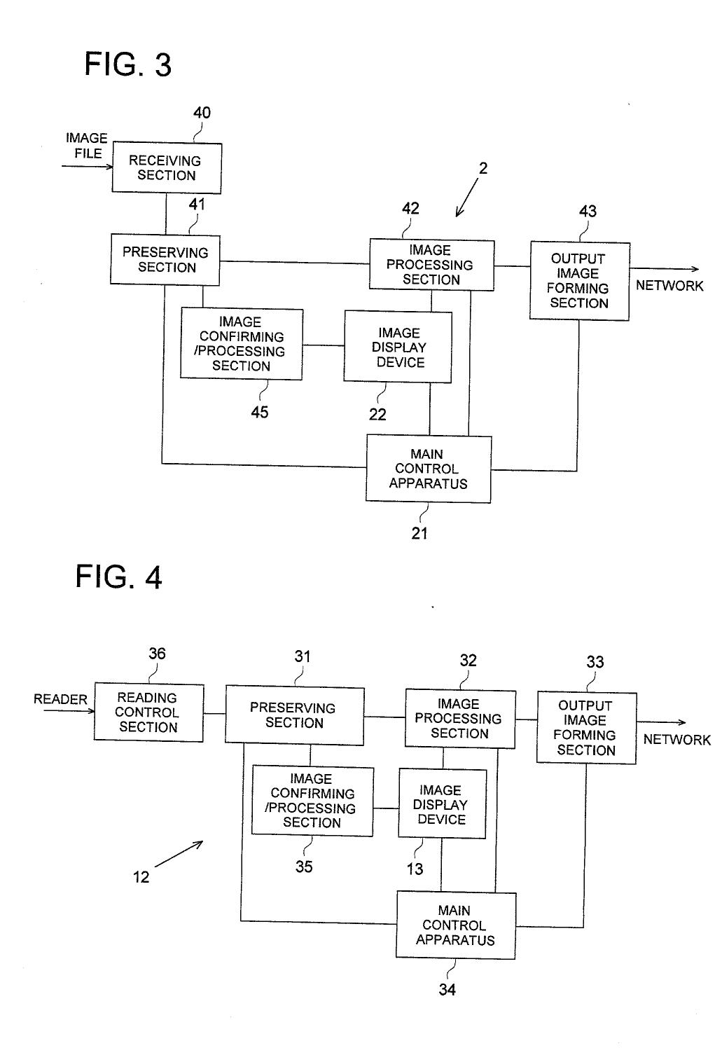

FIG. 3 is a block diagram showing the structure of medical image processing apparatus 2.

a. The medical image processing apparatus 2 shown in FIG. 3 is provided with main control apparatus 21 that controls operations of the whole radiographing system for radiographic images and with image display device 22 for displaying digital image data which are composed of a CRT display and a liquid crystal panel and obtained by medical image generating apparatus 1, and it can be constituted with a personal computer, and includes an information inputting device such as an input key board and a mouse.

As shown in FIG. 3, the image processing apparatus 2 further includes receiving section 40 that receives an image file from image generating apparatus 1 or the like, preserving section 41 that stores information such as an image file that is composed of a hard disc and RAM and received, image processing section 42 that conducts image processing for image information in the image file, output image forming section 43 that forms an output image to be outputted to an outer apparatus, and image confirming/processing section 45 that makes image display device 22 to display reduction images for confirming received images. The sections 40-43 and 44 as well as the image display device 22 are controlled by the main control apparatus 21.

b. Functions of the medical image processing apparatus 2 are as follows, and each function is controlled by the main control apparatus 21.

1) An image file is received by the receiving section 40 from medical image generating apparatus 1.

2) The image file is preserved temporarily in preserving section 41.

3) Image quality is confirmed by reduction images prepared by image confirming/processing section 45.

4) Image processing is carried out on image processing 4 section 42.

5) An output image is formed by output image forming section 43.

6) An output image is transmitted to an outer apparatus such as image server 5 through the network 10.

B. Information

Information handled by the medical image processing apparatus 2 can be classified into the following five types of information.

a. Conditional Information

This is conditional information with which an image file is received and is outputted to an outer apparatus such as image server 5 as a processed image file, and it includes the following.

(a) Image Processing Information

Information relating to gradation processing and frequency processing in image processing section 42.

(b) Output Apparatus Information

This is information about an outer apparatus such as image server 5 that reproduces and outputs image data, and an output area, magnification and reduction rate, output format (multi-format, split radiographing format), overlay and existence of gradation processing and frequency processing are designated for each outputting apparatus such as image server 5.

(c) Overlay Information

This includes information of existence and position of overlay such as AP/PA, R/L and comment.

(d) Specific Designation

Protection information: Even after image output, an image file is preserved until protection is canceled.

Reservation (pending) information: Transmission is reserved. Designation is made when transmission is needed after reviewing an image.

Priority (emergency) information: This is designated when outputting is needed preferentially, such as the case of emergency radiographing.

b. Patient Information

This is information relating to a patient.

(a) Patient ID Information

It includes an ID number, a full name, the distinction of sex and the date of birth all of a patient.

(b) Order Information

This is information with which a doctor requests radiographing.

This includes information about the conditions of a patient and instructions for the date and method relating to the request of inspection.

c. Information of Implementation

This is information relating to the results of receiving and image processing.

(a) The results of receiving and the date and hour of radiographing are included.

(b) Image Processing Result

This is a result of calculation of an image processing parameter, and image data are subjected to image processing based on this result in the case of outputting.

(c) System Information

This includes a part of system information such as a system structure at a point of time when radiographing is conducted.

d. System Information

(a) Information for managing and controlling the system shown in FIG. 1.

(b) Structure the system shown in FIG. 1 (an outer apparatus such as connected image server 5 and its name),

(c) A parameter and a table for controlling apparatuses constituting the system shown in FIG. 1.

(d) Setting information relating to medical image generating apparatus 1 representing an inputting apparatus.

(e) Setting information relating to an outputting apparatus such as information of imager 6 and HOST information

e. Image Data

(a) Image data received from medical image generating apparatus 1.

(b) Reduction image data for display prepared from image data for image confirmation.

(c) Reduction image data for image processing for processing reduction image for display at image confirming/processing section 45.

(d) Output image data subjected to gradation processing and frequency processing.

C. File

A file handled by medical image processing apparatus 2 is preserved in preserving section 41, and it can be classified into the following files in seven types.

a. Condition File

A condition key is a key wherein image processing conditions for image file and output conditions are set in advance, and it has a condition file that corresponds to each condition key. The condition file is composed of the condition information mentioned above. It is classified in terms of radiographing regions (lung, abdomen, head and others), radiographing posture (standing posture, lying posture and others), radiographing direction (front, side and others), characteristics of a patient (the distinction of sex, age, physical structure and others), the name of a disease and a radiologist, and a name and radiographing information corresponding to each of them are established in advance. Main control apparatus 21 establishes a condition file group for each of classified plural classifications, then, sets plural condition files for each condition file group thus established, and preserves in preserving section 41. The optimum condition is selected in the course of generating images.

b. Image Header File

After receiving, an image header file is prepared. The header file is composed of a reservation file of the radiographing (namely, radiographing information, patient information) and information of conducting radiographing. When a user refers to radiographing information, patient information and information of conducting radiographing for changing, the user refers to an image header file.

c. Reduction Image File

This represents image data which are obtained by reducing image data at a certain reduction ratio.

(a) Reduction Image Data for Display

This reduction image for display is used by data displayed on image display section 22 in FIG. 3.

(b) Reduction Image Data for Image Processing

This represents reduction image data for calculating a parameter which conducts image processing. The reduction rate is determined so that a length of one pixel after reduction may be the same as a length designated in advance. Due to this, it is possible to correct the difference in a size of a pixel to be read with the image after being reduced. Calculation of a parameter for image processing is conducted by the reduction image for image processing, and image data are not used.

d. Image File

(a) The image file is composed of image collateral information (image header) and image data.

(b) The image header is composed of condition information, patient information and information of implementation.

When a user refers to condition information, patient information and information of implementation to change, the image header is consulted.

e. Output Image File

This is a file of output image data which have been subjected to designated processing among frequency processing, gradation processing, overlay, rotation and enlargement and reduction.

f. System File

This is one wherein the pieces of information mentioned above are filed.

D. Input and Display of Main Information

a. Received Image Information Display

Received images are displayed on a thumb-nail basis.

b. Output Information Display

1) An output size, a direction, a trimming position, an output position and enlargement reduction methods are designated. These are registered in a condition file in advance.

2) When a condition key is selected, an output area and an output image area are determined by the condition designated in advance, and are displayed on a screen of image display device 22. A size of the output zone display area on the screen of the image display device 22 is assumed to be the maximum output area. The output area and an output image area are displayed graphically on the output zone display area. Due to this, it is possible to select and confirm an appropriate output area and output image area for each apparatus.

c. Overlay Information

1) It is designated whether or not “AP”, “PA”, “R”, “L”, comment and a division are overlaid, or where they are overlaid, and they are registered in a condition file in advance.

2) Output images are displayed on an output zone display area on the screen of the image display device 22, and overlay information is displayed graphically there.

3) It is possible to select an appropriate overlay and to designate its position.

4) It is possible to confirm that a portion screened by the overlay to be invisible is not present. When the overlay causes troubles on diagnoses, it can be moved.

d. Inputting and Output of On-line Information from RIS

1) Orders from a doctor are inputted. The orders thus inputted are converted into the format of this system to be preserved in the reservation file. The radiographing region and radiographing method are converted into corresponding radiographing conditions.

2) An image header file is converted into the format on the RIS side, and outputted.

e. Image List

An image file can be displayed as a list.

E. Image Confirming Procedures

a. Operations of System in Image Confirmation

(1) An image file is received from medical image generating apparatus 1, and is stored in preserving section 41.

(2) The image file stored in a storage medium of the preserving section 41 is reduced at the reduction rate designated by image confirming/processing section 45 in advance.

(3) Reduction images are displayed successively on the screen of image display device 22.

(4) After receiving and completion of display, digital image information is subjected to image processing in the method designated in advance by a radiographing condition key, and is displayed again on image display device 22. Reduction images are used to determine a parameter for image processing.

(5) Images which are displayed successively on the image display device 22 and are subjected to gradation processing after being displayed are displayed again.

(6) When an operator observes received images displayed on the image display device 22 and judges that they are normal images, a key for confirming the completion of receiving is inputted from a character information inputting apparatus, thus, image confirmation is completed.

(7) When patient information, image processing methods and output methods need to be changed, it is possible to input new information from a character information inputting apparatus.

(8) When an image confirming key is pressed, image confirmation for that image is completed, and the following image is displayed automatically.

(9) When an image has a problem, it is possible to change image processing. By reserving it, it is possible to change image processing in detail later.

(10) When an image confirming key is inputted, image confirmation is completed, and the following processing is conducted.

1) The image file is preserved in preserving section 41 as a confirmed image file.

2) Images whose image confirmation has been finished are registered in a cue for outputting to an outer apparatus.

3) Then, the received image file is displayed so that images may be confirmed.

(11) When a reservation key is inputted, image confirmation is completed.

F. Output

1) Output is conducted on a non-synchronization basis with image confirmation.

2) A cue is made and controlled for each outer apparatus, and each cue operates independently each other, and does not influence each other. Therefore, outputting is conducted for each apparatus on a non-synchronization basis.

3) The whereabouts of the image in terms of registration in a cue of an outer apparatus is preserved in preserving section 31 as a cue registration table, and it is updated and controlled for each registration and cancellation.

4) An image registered in the cue is outputted to an outer apparatus in the order of registration, and the image whose outputting is finished is deleted from the cue.

5) When carrying out outputting, an image file stored in preserving section 31 is specified from numbers registered in the cue.

6) An output image is formed under the condition preserved in the image file. The image header is converted into the format determined for each outputting apparatus, and is transmitted together with image data.

G. Forming Output Image

a. An output image is formed by output image forming section 43 mainly through the following processing.

1) Image data are read from preserving section 31 to a memory for images.

2) Frequency processing is conducted.

3) Equalization processing is conducted.

4) Gradation processing is conducted.

5) Rotation of an image is carried out.

6) Mirror reversing is conducted.

7) Enlargement and reduction are carried out.

8) Overlay is carried out.

b. With respect to each of 2)-8), whether it is executed or not can be designated by condition information for each outputting apparatus.

c. It is possible to designate that image data subjected to designated processing of each of 2)-8) are preserved as processed image data file. Re-processing of common processing section of output image for each output apparatus is removed.

d. For example, when an enlargement rate and a reduction rate of an output image for each output apparatus are different from others, if images which have been subjected to processing up to 6) are preserved, it is possible to shorten a period of time for 2)-6) by reading images which have been subjected to processing up to 6) and by processing and transferring only 7) and 8), when transmitting to another apparatus.

e. Processing 5) and 6) are conducted simultaneously with either one of 2), 3) and 4). Access of memory is reduced, and processing time can be shortened.

H. Utility Function

a. As a utility for a user, some functions are provided thereto. Utility function is restricted by a password for each of general user, a manager and a maker. In particular, for a change of information relating to images, a password of a manager is required for security.

b. Image File Operation

1) An image file list is displayed, and information concerning images preserved is displayed on image display device 22 in the order of receiving.

2) When a desired image is selected from the list, patient information, condition information and images are displayed in the same form as in the screen in the case of image confirmation.

3) Patient information, image processing methods and outputting methods can be changed.

4) With regard to the image designated to be “reservation” in the case of radiographing, the “reservation” can be canceled by reconfirming here.

5) The order of outputting can be changed, including whether outputting to each outer apparatus is conducted or not.

c. Radiographing Record, Emission Record

1) Radiographing information and patient information are processed statistically, and are provided to a user as a radiographing record and an emission record.

2) The number of shots per each radiographing region for a designated period and a list of radiographing conditions for shots per day can be outputted.

d. Customizing

A screen and operating procedures can be customized for each user.

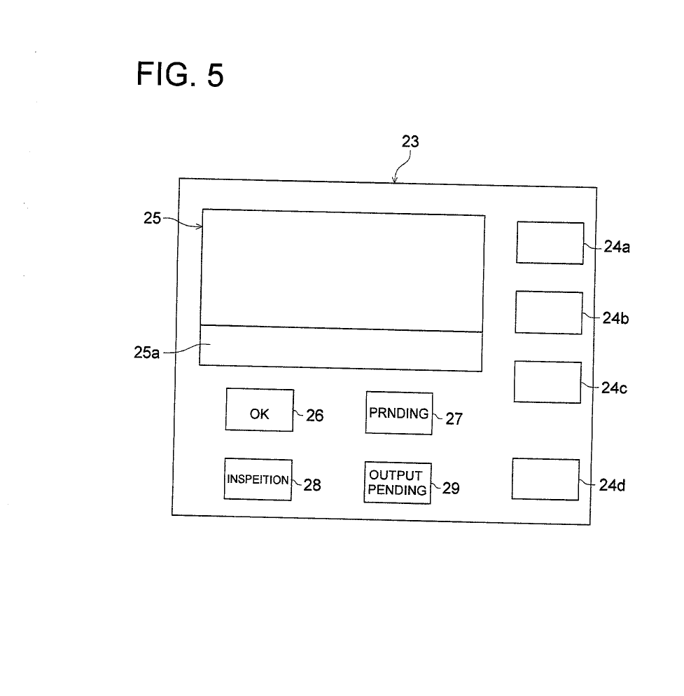

Next, image confirmation conducted in the image processing apparatus in FIGS. 1 and 3 will be explained. FIG. 5 is a diagram showing an example of an image confirming screen displayed on image display device 22 of the image processing apparatus.

An operation flow in the ordinary case on image confirming screen 23 shown in FIG. 5 will be explained. First, main control apparatus 21 of medical image processing apparatus 2 judges whether information to designate “inspection pending” is included in medical image information received from image generating apparatus 1 or not, and whether information to designate “output pending” is included in medical image information received from image generating apparatus or not.

(1) When the main control apparatus 21 of medical image processing apparatus 2 judges that medical image information received from image generating apparatus 1 includes neither information to designate “inspection pending” nor information to designate “output pending”, the medical image processing apparatus 2 conducts the following operations. In the medical network system shown in FIG. 1, the medical image processing apparatus 2 displays plural reduction images about medical image information received from image generating apparatus 1 on plural reduction screen areas 24a, 24b, 24c and 24d of the image confirming screen 23 in the order of receiving.

(2) Next, the forefront image on the reduction screen area 24a is displayed on confirming area 25 for confirming images.

(3) Collateral information of image information is displayed simultaneously on information area 25a of confirming area 25. The collateral information includes condition information, patient information and information of implementation as stated above.

(4) When a user (radiologist) clicks OK button 26 after checking an image on the confirming area 25 and confirming that the image is OK, image confirmation is completed, the medical image processing apparatus 2 starts outputting the image to transmit, for example, to image server 5 in FIG. 1.

(5) An image on reduction screen area 24b received next is displayed on the confirming area 25, and the next image is subjected to image confirmation.

(6) For example, when pending button 27 is clicked here, image confirmation in the medical image processing apparatus 2 is discontinued, and output of the image is not started.

(7) An image received after that is displayed on the confirming area 25, and the next image is subjected to image confirmation.

Next, there will be explained image confirmation in the case wherein image information has a flag concerning whether inspection pending or not in collateral information.

(1) When image information received includes information to designate “inspection pending”, main control apparatus 21 of the image processing apparatus 2 controls so that outputting may be reserved automatically until all images in the same inspection are received. In this case, when OK button 26 is clicked on screen 23 in FIG. 5, image confirmation is completed. However, warning to the effect of “inspection pending” is displayed on area 28, and outputting is not started. This warning calls a user attention and prevents erroneous operations.

(2) An image received after that is displayed on the confirming area 25, and the next image is subjected to image confirmation.

(3) Then, when the last image is clicked with OK button 26 after all images in the same inspection are received, image processing apparatus 2 controls so that inspection pending may be canceled automatically, and starts outputting.

Incidentally, on an image in “inspection pending”, a mark of “inspection pending” is provided to the list so that an operator may notify.

It is also possible to reserve inspection in the case of “Yes” and to conduct ordinary processing in OK in the case of “No”, by displaying a message to the effect of “inspection pending?” on screen 23 when OK button 26 is clicked.

Next, there will be explained image confirmation in the case where image information has a list of collateral information for inspection pending.

Judgment of “inspection pending” in the case wherein image information received by the image processing apparatus includes a list of collateral information for inspection pending is conducted by main control apparatus 21 in the following way.

(1) Medical image generating apparatus 1 puts information of “inspection pending” in collateral information of image file and transmits them, and image processing apparatus 2 receives them through the network 10.

(2) Judgment is made depending on contents of information in which collateral information is established in advance. For example, a condition file number can be used for judgment in the case of a condition file for long-roll film radiographing and a condition file for contrast medium radiographing, a form of outputting can be used for judgment for multi-format (split radiographing), and further, an inspection ID and a patient ID can be used for judgment in the case of a specific code.

Next, there will be explained about image confirmation in the case where image information includes information that designates output pending. When image information received by image processing apparatus 2 includes information that designates “output pending”, main control apparatus 21 of the image processing apparatus 2 controls so that outputting is automatically reserved. Owing to this, judgment by a user and a burden of operations are lightened, and erroneous operations can be prevented. In this case, when images are confirmed on screen 23 shown in FIG. 5, and OK button 26 is clicked, image confirmation is completed, but, a warning to the effect of “output pending” is displayed on area 29, and outputting is not started. This warning calls a user attention and prevents erroneous operations.

Then, images received next are displayed on screen 23, and next images are subjected to image confirmation. For the images which are in a position of “output pending”, there is given a mark of “output pending” or a mark of “not outputted yet” on a list so that an operator may notify.

Next, when outputting is required, images are referred again, and OK button 26 is clicked or outputting is designated. Incidentally, it is also possible to take an arrangement wherein when OK button 26 is clicked, a message to the effect of “output pending needed?” is displayed on screen 23, and outputting is reserved for “Yes”, while, ordinary processing in the case of OK is conducted for “No”. Further, judgment of “output pending” can be carried out in the same way as in judgment of “inspection pending”.

Next, there will be explained an action to be taken in the case where unconformity is discovered in checking in the course of receiving of an image file of image information received by image processing apparatus 2. Collateral information of the image information received by main control apparatus 21 of the image processing apparatus 2 is analyzed, and control is made to reserve outputting when the collateral information is judged to have unconformity.

### EXAMPLE 1

In a plurality of images in the same inspection, when there is unconformity in patient information (an ID number, a full name, the distinction of sex and the date of birth of a patient), it is judged to be unconformity. Since the same inspection is for one patient, unconformity in the patient information hints a possibility that information of an image file has an error in it.

### EXAMPLE 2

When the image information is the same as the information received, it is judged to be unconformity.

When an image which is the same as the image that has already been settled and outputted to an image server is received on a doubled basis, it hints that some sort of unconformity is caused.

When image information received by image processing apparatus 2 is judged to have unconformity as stated above, main control apparatus 21 controls so that outputting is automatically reserved. Owing to this, judgment by a user and a burden of operations are lightened, and erroneous operations can be prevented. In this case, when images are confirmed on screen 23 shown in FIG. 5, and OK button 26 is clicked in the same way as in “output pending”, image confirmation is completed, but, a warning to the effect of “output pending” is displayed on area 29, and outputting is not started. This warning calls a user attention and prevents erroneous operations.

Then, images received next are displayed on screen 23, and next images are subjected to image confirmation. For the images which are in a position of “output pending”, there is given a mark of “output pending” or a mark of “not outputted yet” on a list so that an operator may notify.

In the medical network system of the present embodiment, it is possible to output a plurality of related images in the same inspection as a series of images after image processing, because output of image information after image processing is automatically reserved at medical image processing apparatus 2 and outputting is started after the inspection pending is canceled, in the case of inspection pending. In the case of output pending, on the other hand, it is possible to wait outputting until the moment when causes for output pending are removed, because output of image information after image processing is reserved automatically at medical image processing apparatus 2, and outputting is started after the output pending is canceled.

The invention has been explained as stated above, referring to the embodiments to which, however, the invention is not limited and can be varied in many ways within a range of technical conception. For example, in addition to the aforesaid CR apparatus wherein radiographic images are read from a stimulable phosphor panel on which radiographic image information of a patient is recorded, the medical image generating apparatus may naturally include a radiographing apparatus employing an X-ray flat panel detector, CT (computed tomography: computer tomography device), MRI (magnetic resonance imaging: nuclear magnetic resonance apparatus), DR (digital radiography), and US (ultrasound: ultrasound diagnostic apparatus), or each medical image generating apparatus may also be connected to the medical network system of the invention.

The medical image generating apparatus, the medical image processing apparatus and the medical network system all of the present invention make it possible to output a plurality of related images as a series of images after image processing, and to help a user for judging whether the user must reserve outputting or not, and thereby to prevent erroneous operations.

What is claimed is:

1. A medical image processing apparatus, comprising:
a means for receiving medical image information from another apparatus;
a means for conducting image processing of said medical image information;
a means for reserving output of said medical image information after image processing is conducted when information of inspection pending is set in said medical image information; and
a means for warning said inspection pending.

2. A medical image processing apparatus, comprising:
a means for receiving medical image information from another apparatus;
a means for conducting image processing of said medical image information;
a means for reserving output of said medical image information after image processing is conducted when information of inspection pending is included in said medical image information includes information; and
a means for canceling said inspection pending and for starting said output of said medical image information.

3. A medical image processing apparatus, comprising:
a means for receiving medical image information from another apparatus;
a means for conducting image processing of said medical image information;
a means for reserving output of said medical image information after image processing is conducted when information of inspection pending is included in said medical image information;
a means for warning said inspection pending; and
a means for canceling said inspection pending and for starting said output of said medical image information.

4. The medical image processing apparatus of claim 1, wherein said medical image information represents a plurality of images in a long-roll film radiographing, a plurality of images in a multi-format or a plurality of images in contrast medium radiographing.

5. A medical image processing apparatus, comprising:
a means for receiving medical image information from another apparatus;
a means for conducting image processing of said medical image information;
a means for judging whether unconformity exists in said medical image information or not; and
a means for reserving output of said medical image information after image processing is conducted when said unconformity exists.

6. A medical image processing apparatus, comprising:
a means for receiving medical image information from another apparatus;
a means for conducting image processing of said medical image information;
a means for judging whether unconformity exists in said medical image information or not; and
a means for conducting warning when said unconformity exists.

7. The medical image processing apparatus of claim 5, wherein said unconformity is an occasion wherein patient information is different in plural images for a same inspection.

8. The medical image processing apparatus of claim 5, wherein said unconformity is an occasion wherein information of said image is the same as one which has been received.

9. A medical image processing apparatus, comprising:
a means for receiving medical image information from another apparatus;
a means for conducting image processing of said medical image information;
a means for reserving output of said medical image information after image processing is conducted when information of output pending is included in said medical image information; and
a means for warning said output pending.

10. A medical image processing apparatus, comprising:
a means for receiving medical image information from another apparatus;
a means for conducting image processing of said medical image information;
a means for reserving output of said medical image information after image processing is conducted when information of output pending is included in said medical image information; and
a means for canceling said output pending and for starting said output of said medical image information.

11. A medical image processing apparatus, comprising:
a means for receiving medical image information from another apparatus;
a means for conducting image processing of said medical image information;
a means for reserving output of said medical image information after image processing is conducted when information of output pending is included in said medical image information;
a means for warning said output pending; and
a means for canceling said output pending and for starting output of said medical image information.

12. A medical network system, comprising:
a medical image generating apparatus for generating medical image information and for transmitting said medical image information to another apparatus: and
a medical image processing apparatus for receiving said medical image information through a network and for conducting image processing;
wherein when information of inspection pending or output pending is included in medical image information to be transmitted from said medical image generating apparatus, said medical image processing apparatus reserves output of said medical image information after image processing is conducted; and
said medical image processing apparatus cancels said inspection pending or said output pending and starts output of said medical image information in a predetermined condition.

13. The medical network system of claim 12, wherein said inspection pending is conducted when said medical image information represents a plurality of images in a long-roll film radiographing, a plurality of images in a multi-format or a plurality of images in contrast medium radiographing; and said inspection pending is canceled when said image processing apparatus receives all of a plurality of images in a same inspection.

14. The medical network system of claim 12, wherein output pending is conducted when there is unconformity in said medical image information received with said image processing apparatus.
